(19) United States
(12) Patent Application Publication
(10) Pub. No.: US 2003/0061527 A1
(43) Pub. Date: Mar. 27, 2003

(54) Method and apparatus for realigning bits on a parallel bus

(75) Inventors: Matthew B. Haycock, Beaverton, OR (US); Bryan K. Casper, Hillsboro, OR (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 09/964,010

(22) Filed: Sep. 26, 2001

(51) Int. Cl. G06F 1/04

(52) U.S. Cl. 713/600

(57) ABSTRACT

An integrated circuit includes an alignment circuit. The alignment circuit includes a plurality of shift registers that are configured based on training bits transmitted to the integrated circuit via a parallel bus. After the shift registers are configured, the alignment circuit automatically aligns the data bits transmitted to the integrated circuit when the data bits are misaligned by one or more bit time intervals during transmission on the parallel bus.

### TECHNICAL FIELD OF THE INVENTION

The present invention relates to data communication, and in particular to data communication via a parallel bus.

### BACKGROUND OF THE INVENTION

Electrical components communicate with each other by transferring data among them via transmission medium such as traces on printed circuit board, cables, optical fibers, or other forms of medium. The data can be transferred one bit after another in a series fashion on a serial bus. The data can also be transferred in multiple bits simultaneously in parallel fashion on a parallel bus.

Buses between components that transmit multiple data bits in parallel typically rely on a clocking mechanism of some form to capture the data bits at the receiver. Conventionally, the frequency of data transmission on parallel buses is limited to a rate that allows timing margin for mismatches in the length of bus lines of the parallel bus, to help ensure the multiple data bits that are captured simultaneously on the bus lines remain aligned at the receiver.

Various methods have been used to raise the data transmission frequency. Many of these methods continue to rely on the assumption that mismatches among the bus lines remain within an allowable margin so that all data bits captured at the receiver remain aligned. With conventional transmission methods, however, if the mismatches among the bus lines exceed the allowable margin due to variations among the bus lines, the data bits captured at the receiver will be incorrect. Further, at some frequency, the allowable margin will begin limiting the rate at which the data bits can be received and aligned at the same clock cycle at the receiver.

For these and other reasons stated below, and which will become apparent to those skilled in the art upon reading and understanding the present specification, there is a need for a method and apparatus to allow higher frequency data transmission between integrated circuits.

### BRIEF DESCRIPTION OF THE DRAWINGS

FIG. 1 shows a diagram of an electrical system.

FIG. 2 shows an alternate electrical system.

FIG. 3 shows a block diagram of an alignment circuit.

FIG. 4 shows exemplary input and output bits of the alignment circuit of

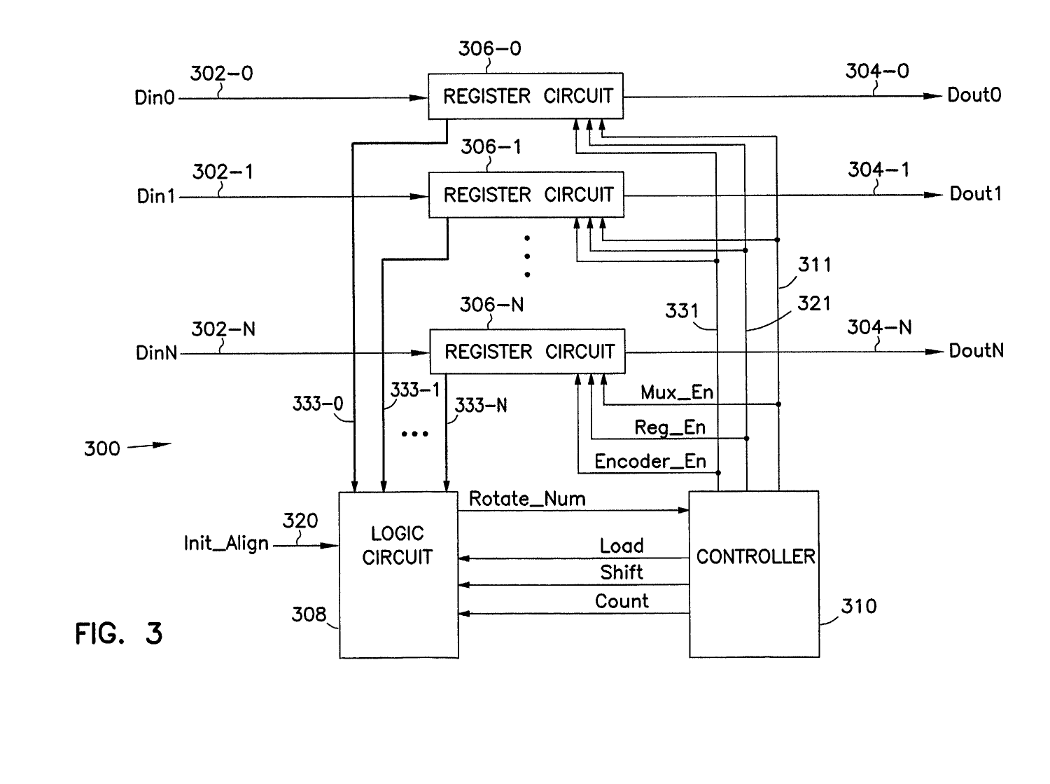

FIG. 3.

FIG. 5 shows a register circuit.

FIG. 6 shows exemplary training bits that are sent to a parallel bus during an initialization process.

FIGS. 7A-7B show exemplary training bits that are captured in a number of registers.

FIG. 8A shows a result of a logic function performed on the bits captured in the registers of FIG. 7A.

FIG. 8B shows an array of bits that is generated based on the result of the logic function performed in FIG. 8A.

FIGS. 9A-9B show the bits of the registers of FIG. 8A before and after the bits have been rotated.

FIG. 10 shows a plurality of register circuits after being set.

FIG. 11 shows a block diagram of a logic circuit.

FIG. 12 shows a state diagram.

FIG. 13 is a flow chart describing a method of configuring an integrated circuit.

### DETAILED DESCRIPTION OF THE INVENTION

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

The method and apparatus of the present invention provide a mechanism to realign data bits at an integrated circuit (IC), when the data bits are misaligned by one or more bit time intervals during transmission of the data bits to the integrated circuit via a parallel bus that connects to the integrated circuit. During an initialization process, a number of test or training bits are transmitted to the IC via each of a number of bus lines of the parallel bus. A number of shift registers of the IC receive the training bits from each of the bus lines. A logic circuit, controlled by a controller, performs a logic function on the training bits in each of the shift registers to determine an actual misalignment among the bus lines. Based on the actual misalignment, each of the shift registers is preset or configured during the initialization process. After the initialization process, since the shift registers are already preset, subsequent or functional data bits transmitted to the IC will automatically be aligned by the shift registers when the functional data bits are misaligned by one or more bit time intervals during transmission on the parallel bus.

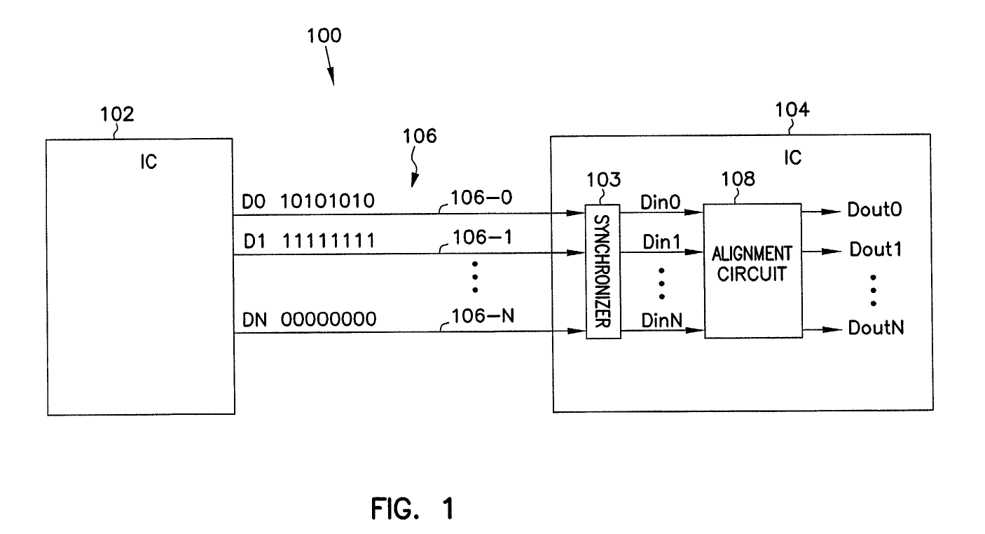

FIG. 1 shows a block diagram of an electrical system 100. System 100 includes a first integrated circuit (IC) 102 and a second IC 104. ICs 102 and 104 connect to a parallel bus 106, which includes a plurality of bus lines 106-0 to 106-N. Each of the bus lines 106 0-N is capable of carrying a signal that represents a sequence of bits. For example, bus line 106-0 carries a signal DO that represents a plurality of bits, indicated by bits 10101010. Bus line 106-1 carries a signal D1 that represents a plurality of bits or bit stream, indicated by bits 1111111. Bus line 106-N carries a signal DN that represents a plurality of bits, indicated by bits 000000. Similarly, other bus lines also carry signals that represent a plurality of bits that include bit ones and zeros. In some embodiments, bus lines 106-0 to 106-N carry multilevel signaling.

The bit ones and zeros in FIG. 1 represent signal levels of the signals D0-DN. For example, bit one represents a “HIGH” signal level (logic 1) and bit zero represents a “LOW” signal level (logic 0). The time interval from the occurrence of one bit to the occurrence of a next bit is referred to as “bit time interval”. In other words, the bit time interval is the time interval during which a bit is valid. In the example shown in FIG. 1, there are eight valid bits that are carried by each of the bus lines, e.g., bits 10101010 of bus line 106-0. Thus, there are eight bit time intervals among the bits carried by each bus line.

In FIG. 1, the signals D0-DN can be transmitted by IC 102 from its outputs connected to bus lines 106-0 to 106-N. In this case, IC 102 acts as a transmitter and IC 104 acts as a receiver. Referring again to FIG. 1, IC 104 includes an alignment circuit 108 connected to bus lines 106 0-N through a synchronizer 103. Alignment circuit 108 receives on each of the bus lines a plurality of bits, such as bits indicated by 10101001, 11111111, and 00000000 on bus lines 106-0, 106-1, and 106-N. When entering synchronizer 103, the plurality of bits on the bus lines may be misaligned. The misalignment among the bits may be one or more non-integer bit time intervals. Synchronizer 103 takes the non-integer part out of the misalignment among the bits. However, the misalignment among the bits may be still one or more integer number of bit time intervals. A method for synchronizing the bits to one or more bit time intervals by synchronizer 103 is disclosed in U.S. Pat. No. 5,623,644. In FIG. 1, any misalignment among the bits will be corrected by alignment circuit 108 such that the data signals Dout0-DoutN that represent output bits will be aligned.

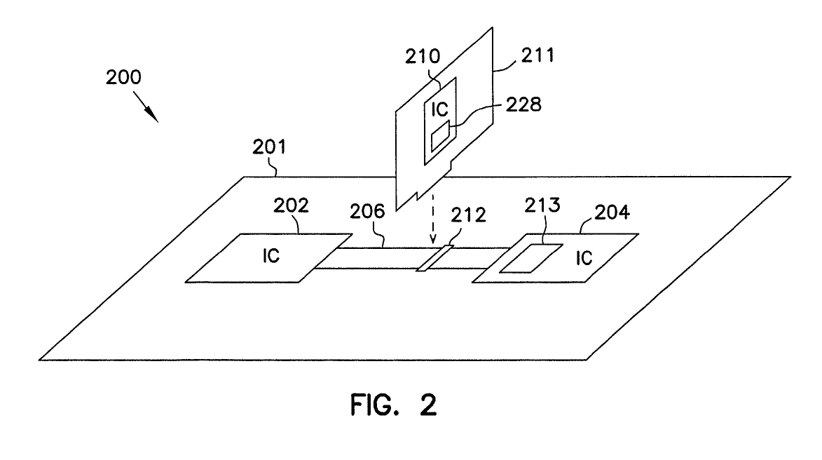

FIG. 2 shows an alternate electrical system 200 according to another embodiment of the invention. System 200 includes a printed circuit board 201 in which a parallel bus 206 is formed. In some embodiments, circuit board 201 is a motherboard of a computer system. Bus 206 is similar to bus 106 shown in FIG. 1. Board 201 also includes ICs 202 and 204, both connected to bus 206. ICs 202 and 204 are similar to ICs 102 and 104 shown in FIG. 1. System 200 further includes an IC 210 located on another printed circuit board 211. IC 204 includes an alignment circuit 213, which is similar to alignment circuits 108. To establish a connection between IC 210 and bus 206, circuit board 211 is inserted into a bus slot 212 that is connected to bus 206. IC 210 includes an alignment circuit 228 that, like alignment circuit 108 shown in FIG. 1, realigns the bits that are received from bus 206 where the bits may have been misaligned by one or more full bit time intervals during transmission on the bus.

In FIG. 1 and FIG. 2, ICs 102, 104, 202, 204 and 210 can be processors, controllers, memory devices, application specific integrated circuits (ASIC) or any type of integrated circuits. These ICs include many circuit elements. However, for simplicity and for concentrating on the invention, only the alignment circuit is shown in ICs 104, 204 and 210.

FIG. 3 shows a block diagram of an alignment circuit 300. Alignment circuit 300 represents alignment circuit 108 shown in FIG. 1. Alignment circuit 300 includes a plurality of inputs 302 0-N to receive a plurality of input signals Din0-DinN, a plurality of outputs 304 0-N to provide a plurality of output signals Dout0-DoutN, a plurality of register circuits 306 0-N, a logic circuit 308, and controller 310. Each of the register circuits connects between one of the inputs 302 0-N and one of the output 304 0-N. For example, register circuit 306-0 connects between input 302-0 and 304-0. Also for example, register circuit 306-N connects between input 302-N and output 304-N.

Logic circuit 308 connects to line 320 to receive an enable signal Init_Align during an initialization process to perform logic functions on data that are contained in register circuits 306 0-N. Register circuits 306 0-N connect to logic circuit 308 via lines 333-0 to 333-N. Controller 310 provides command signals such as the Load, Shift, and Count signals to logic circuit 308. Controller 310 also provides command signals such as Mux_En, Reg_En, and Encoder_En to register circuits 306 0-N via lines 311, 321 and 331. In some embodiments, controller 310 includes a state machine.

In the embodiment represented by FIG. 3, during an initialization process, logic circuit 308 and controller 310 operate to set or initialize register circuits 306 0-N. After the initialization, register circuits 306 0-N remain in the set position to correct for any misalignment among received bits, represented by signals Din0-DinN received at inputs 302 0-N. At output 304 0-N, after the received bits are corrected by register circuit 306 0-N, output bits represented by the Dout1-DoutN signals are aligned.

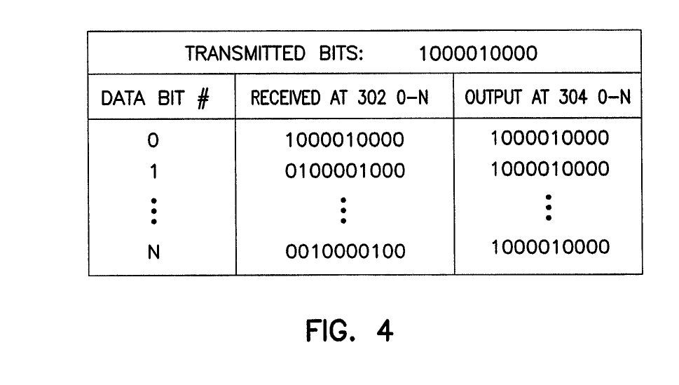

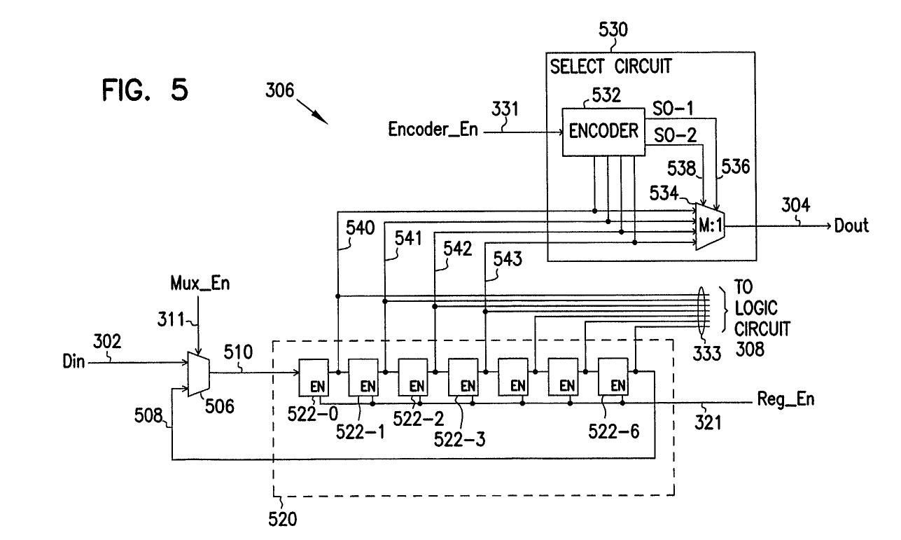

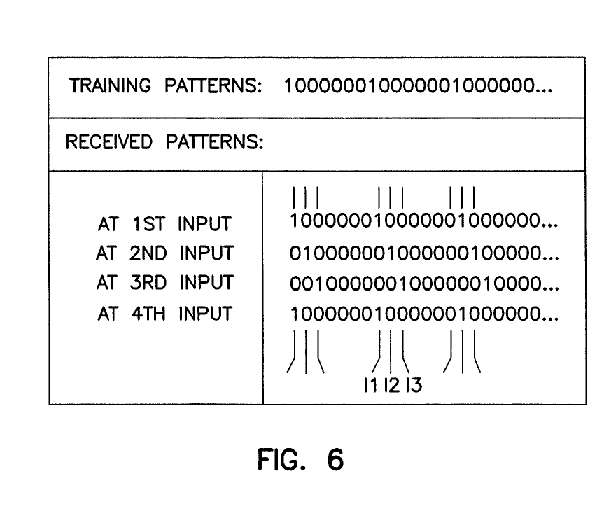

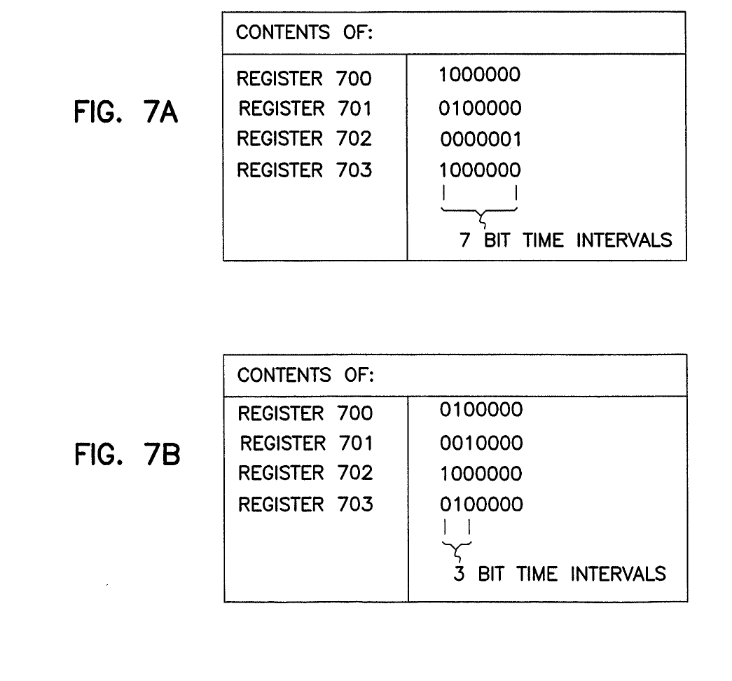

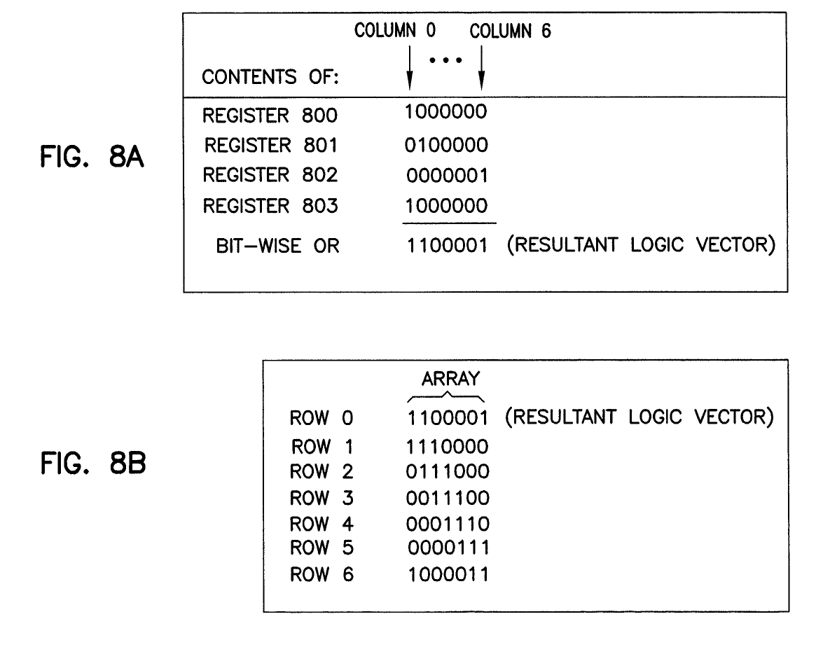

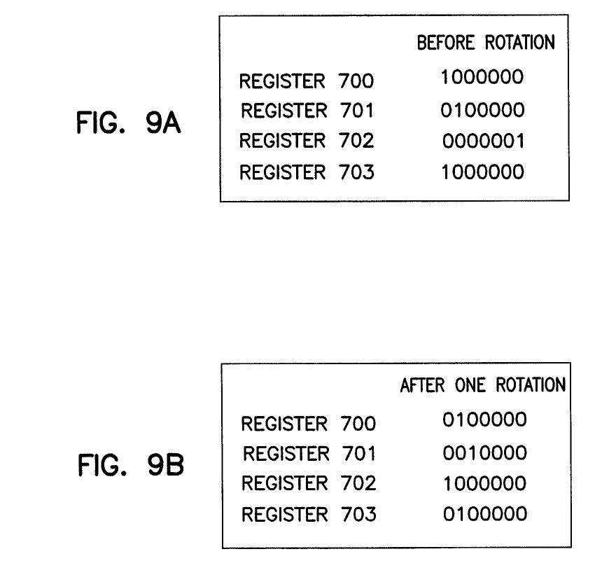

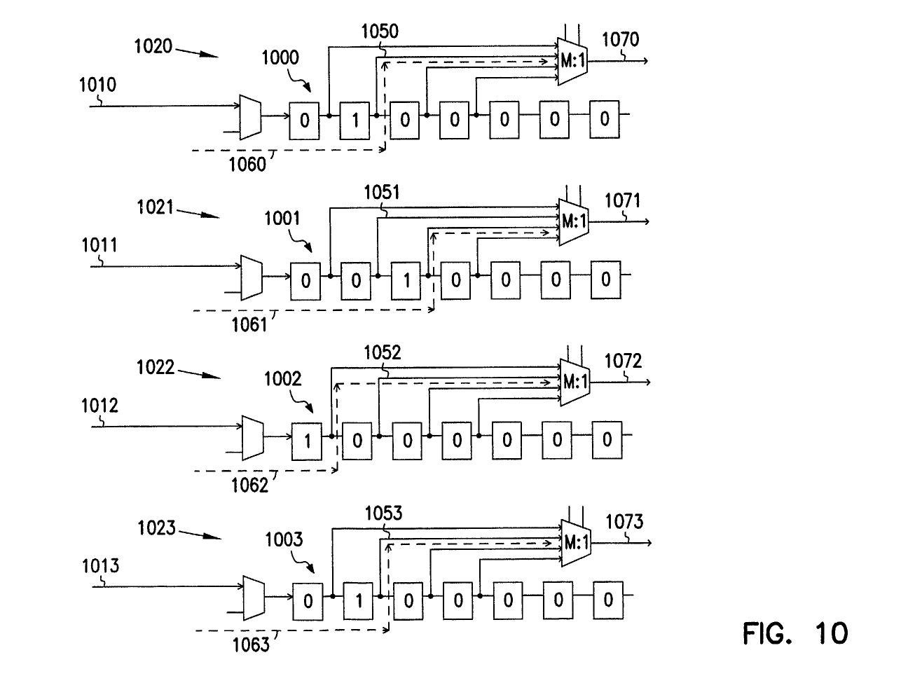

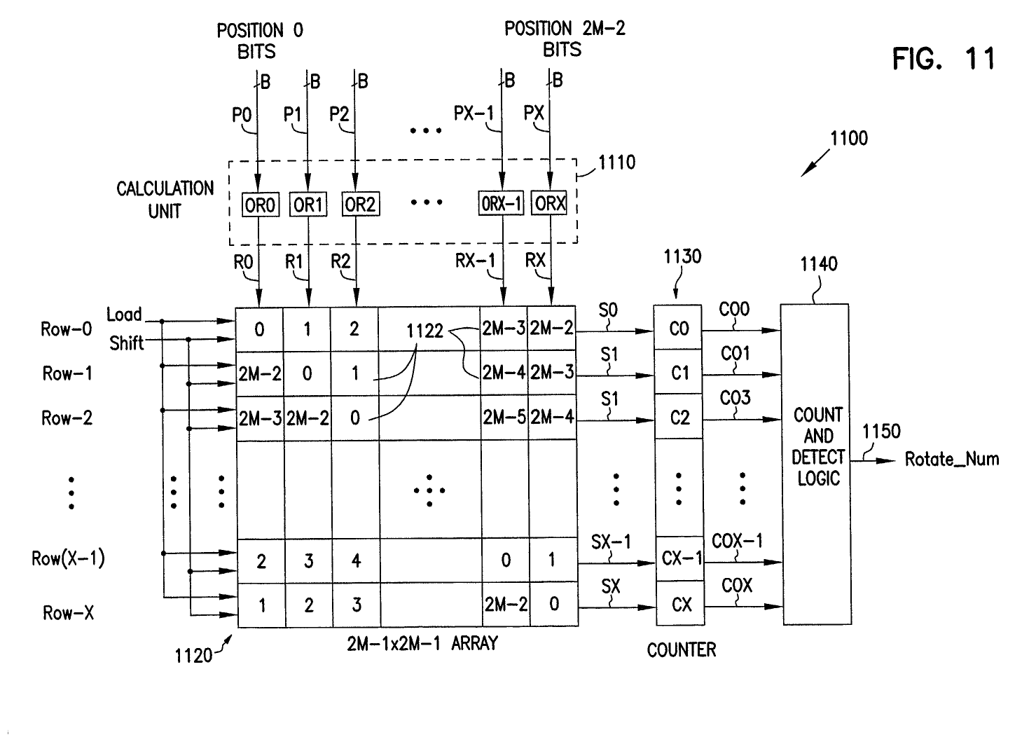

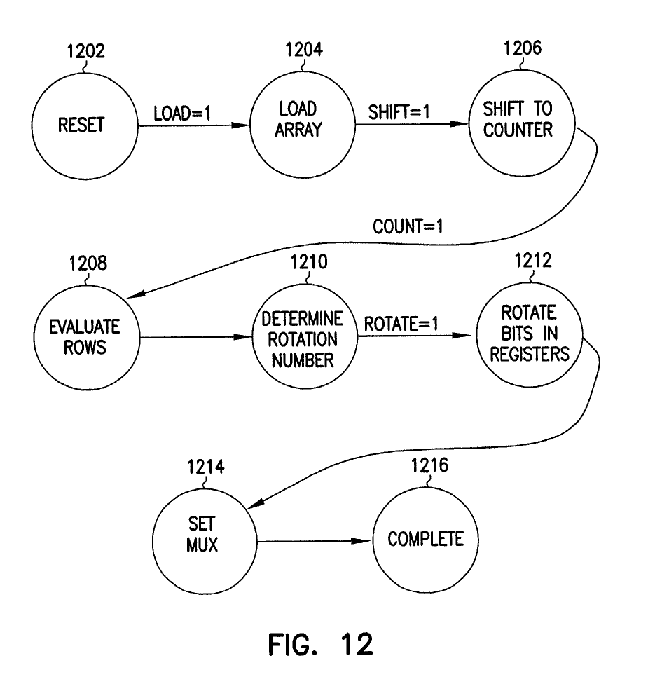

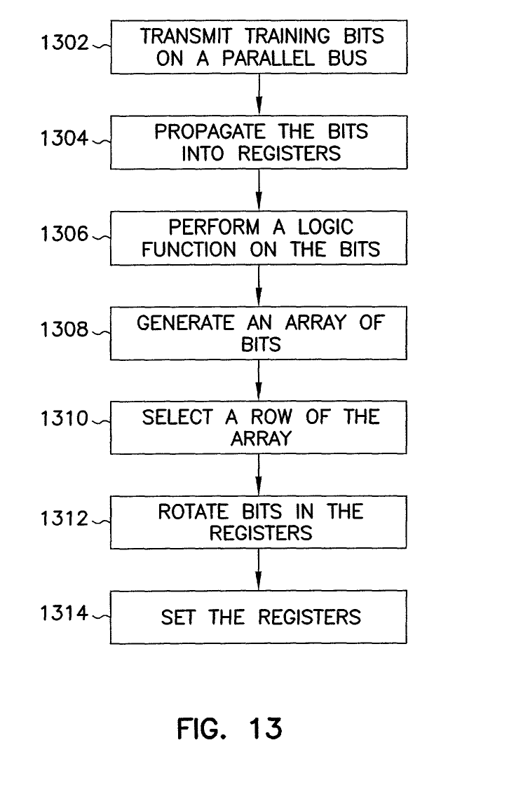

FIG. 4 shows exemplary input and output bits of alignment circuit 300 in operation. In FIG. 4, the TRANSMITTED bits 1000010000 are an example of a sequence of bits that are sent by a transmitter to all lines of a parallel bus such as IC 102 and bus 106 shown in FIG. 1. The RECEIVED bits 1000010000, 0100001000, and 0010000100 are an example of the bits that are received at inputs of an alignment circuit such as inputs 302 0-N of alignment circuit 300 of FIG. 3. As shown in FIG. 4, the received bits at inputs 302 0-N are not aligned with the transmitted bits or with each other. This is indicated by the logic 1 bits among inputs 302 0-N that are not received at the same bit time interval. In FIG. 4, the OUTPUT bits 1000010000, 1000010000, and 1000010000 are the bits that are output at outputs of an alignment circuit such as outputs 304 0-N of alignment circuit 300. As shown in FIG. 4, the output bits at outputs 304 0-N are aligned with each other and with the TRANSMITTED bits.

FIG. 5 shows a register circuit 306. Register circuit 306 represents an example embodiment of each of the register circuit 306-0 to 306-N shown in FIG. 3. Register circuit 306 includes an input connected to line 302 to receive an input data signal Din and an output connected to line 304 to provide an output data signal Dout. Line 302 represents one of the lines 302-0 to 302-N of FIG. 3. Line 304 represents one of the lines 304-0 to 304-N of FIG. 3. Register circuit 306 further includes multiplexer 506. Multiplexer 506 selects between the Din signal on line 302 and a signal on line 508 and passes the selected signal to its output that connects to line 510. MUX 506 is controlled by a select signal Mux_En on line 311.

The signal on line 510 of the output of MUX 506 is provided as an input signal to an input of a shift register 520. Register 520 includes a plurality of register cells 5220 to 522-6. An output of the last register cell 522-6 connects to line 508 such that its content can be shifted and rotated to the first register cell 522-0. Register cells 522-0 to 522-6 have outputs connected to lines 333, which connect to logic circuit 308 (FIG. 3). Lines 333 are represented in FIG. 3 by individual lines 333-0 to 333-N. Register 520 connects to a select circuit 530 via select lines 540, 541, 542 and 543, which connect to the output of register cells 522-0 to 522-3, respectively. As shown in FIG. 5, select circuit 530 does not connect to all register cells, but only to a subset of register cells (register cells 522-0 to 522-3). In general, the number of register cells equals 2M1 and select circuit 530 connects to a subset M number of register cells through M select lines, where M is greater than 1 and is a maximum number of bit time intervals of misalignment among the bits that can be caused by the parallel bus, such as bus 106 (FIG. 1), during transmission.

In some embodiments, select circuit 530 includes an encoder 532 connected to an M:1 MUX 534. Encoder 532 includes inputs connected to lines 540-543 to receive signals from the outputs of register cells 522-0 to 522-3, and outputs connected to MUX 534 via lines 536 and 538 to provide select signals S0-1 and S0-2. Further, encoder 532 is controlled by an enable signal Encoder_En on line 331. The Encoder En signal is provided by controller 310 (FIG. 3). MUX 534 includes inputs connected to lines 540-543 and an output connected to line 304. Encoder 532 activates the S0-1 and S0-2 signals such that for each combination of the S0-1 and S0-2 signals, MUX 534 selects one of the signals on lines 540-543 and passes the signal to its output on line 304 as the Dout signal. In FIG. 5, the Din signal represents one of the Din0-DinN signals shown in FIG. 3; the Dout signal represent one of the Dout0 to DoutN shown in FIG. 3.

In embodiments represented by FIG. 5, register 520 includes seven register cells 522-0 to 522-6, and four output lines 540-543 connected between the register cell and MUX 534. However, the numbers of register cells and the number of output lines between the register cells and MUX 534 can be different in other embodiments. It will become apparent after the description of the initialization process that the number of the register cells and the number of output lines that connect to MUX 534 are chosen in part as a function of the maximum number of misalignment among bus lines.

The various embodiments of the present invention perform an initialization process to align misaligned bits on the parallel bus prior to data transmission taking place. The initialization process is now described. At the beginning of the initialization process, the INIT_ALIGN signal shown in FIG. 3 is activated to start the process. After the initialization process, register circuits 306 0-N remain in the set position to automatically align misaligned bits during transmission on the bus. In general, at the beginning of the initialization process, a repeated pattern of test bits or training bits are sent from a transmitter to a receiver via a parallel bus. For example, in FIG. 1, the training bits are sent from IC 102 to IC 104 via parallel bus 106. When the training bits are received at IC 104, an alignment circuit of IC 104, such as alignment circuit 300 of FIG. 3, calculates the actual misalignment among the training bits by performing a logic function on the training bits. Based on the actual misalignment, register circuits 306 0-N are set accordingly. After register circuits are set, they remain in the set position to correct for any misalignment of bits during transmission on the parallel bus.

In some embodiments, the initialization process is only performed once, for example, only at powerup. In other embodiments, the initialization process is performed multiple times. For example, the initialization process can be performed in response to any stimulus, such as system reset, a hot swap of a component or board, a change in operating condition, or the like.

FIG. 6 shows exemplary training bits that are sent to a parallel bus during the initialization process. The training bits include a plurality of patterns of training bits. In FIG. 6, the patterns are indicated by TRAINING PATTERNS. Each pattern includes one bit that represents logic 1 (or binary value 1) and six bits that represents logic 0 (or binary value 0). In some embodiments, each pattern of training bits includes one logic 1 followed by 2M−2 logic 0 bits. Thus, M is a maximum number of bit time intervals of misalignment among the bits that can be caused by the parallel bus during transmission. Thus, M is known during the design of the parallel bus and the receiver. In other words, M is the number of bit time intervals of misalignment that the IC, such as IC 104 of FIG. 1, can tolerate to maintain proper operation. For simplicity, M is assumed to be four in this description. However, M can be any number that is greater than 1. In the example where M is equal to four, then 2M−2 is equal to 6. Therefore, the pattern of training bits shown in FIG. 6 includes 2M−2=6 logic 0 bits following the logic 1 bit.

The pattern of training bits is repeatedly transmitted on each of the bus lines and is received at each of the register circuits such as register circuit 306 shown in FIG. 5. In FIG. 5, register 520 includes seven register cells 522-0 through 522-6. The number of register cells is not arbitrary. In some embodiments, the number of register cells of each register is equal to 2M−1. In the example, M=4, thus, the number of register cells in each register is seven ((2×4)−1). In some embodiments, the number of register cells is greater than 2M−1.

For simplicity, it is assumed that the parallel bus includes four bus lines. That is, the number of bus lines in FIG. 1 is B=4. In these embodiments, there are four register circuits, such as register circuit 306, each being connected to one of the B=4 bus lines. The pattern of training bits shown in FIG. 6 is allowed to propagate across each of the bus lines and into the register cells of each of the four registers. In FIG. 6, the RECEIVED PATTERNS represent the patterns of bits that are received at a first, second, third and fourth input of the four register circuits connected to the B=4 bus lines. As can be seen in FIG. 6, the bits among the received patterns are misaligned. The number of bit time intervals of misalignment among the bits in this case is three. By looking at the column of the received patterns, the logic 1 bits are received at three different bit time intervals, indicated at I1, I2 and I3. This is the actual number of bit time intervals of misalignment among the bits during transmission on the bus lines. Notice that the actual number of misalignment is different from the maximum number (M) of misalignment that can be caused by the bus lines.

In FIG. 5, the bits contained in the register cells can be shifted and rotated right. That is, the content of each of the register cells 522 0-6 can be shifted to the right, and the content of the last register cell 522-6 can be rotated to replace the content of the first register cell 522-0. At the beginning of the initialization, the select signal Mux_En is activated by a controller, such as controller 310 shown in FIG. 3, such that MWX 506 operates to pass the pattern of training bits through the MUX. After propagating into the register cells, the bits are allowed to shift.

When the training pattern has been transmitted for a time period sufficient to ensure that the pattern has filled register cells 522 0-6, controller 310 deactivates the signals on line 321 to disable the register 520. By the time register 520 is disabled, there are exactly one logic 1 bit and six logic 0 bits captured in arbitrary locations in the register cells. The positions of the logic 1 bit and logic 0 bits in each register cell are arbitrary, because the time at which the registers are disabled is arbitrary with respect to the incoming patterns.

Since register circuit 306 represents an embodiment of each of the register circuits 306-0 to 306-N of FIG. 3, the registers represented by register 520 of register circuits 306-0 to 306-N are also disabled after the pattern has filled the registers. After all registers are disabled, logic circuit 308 and controller 310 of FIG. 3 operate to correctly set the register to correct for any misalignment among received bits. The setting or configuration of the register, such as register 520 of FIG. 5, is described in detail after the description of the operation of the logic circuit of FIG. 11.

FIG. 7A shows exemplary training bits that are captured in four registers 700, 701, 702 and 703. Each of the registers 700-703 is similar to register 520 shown in FIG. 5. Therefore the training bits captured in registers 700-703 are located in register cells such as register cells 522 0-6 of register 520. Again using the same B=4 bus lines, as shown in FIG. 7A, after registers 700-703 are disabled, capturing the training pattern in the bits of registers 700-703, a continuously running training pattern can be modeled in the registers simply by rotating the bits in the register cells of the registers. In the example of the training bits, by the time registers 700-703 are disabled, the bits shown in FIG. 7A indicate an apparent 7 bits of misalignment. In other words, the spacing in time or bit time interval of each logic 1 bit in each register is seven bit time intervals apart. However, the 7 bits of misalignment may not be an actual misalignment, because if the register were disabled one bit time interval later, the training bits captured in the register would become the ones shown in FIG. 7B.

In FIG. 7B, the locations of the logic 1 bits across the columns of register cells of registers 700-703 indicate an apparent misalignment of just 3 bits. That is, the spacing in time of each logic 1 bit in each register is equal to three bit time intervals. Therefore, the training bits captured after the register is disabled may not indicate the actual misalignment. A method of determining an actual amount of bit time intervals of misalignment among the bits is specified in the following description.

After the registers are disabled, a logic OR function is performed on the bits of the registers. The logic OR function generates the bit-wise OR of each bit position of the register cells of registers 700-703. For a B-bit wide bus, a B-bit OR function is performed. The OR function performed to the bits is shown in FIG. 8A. In FIG. 8A, the OR function is performed on the bit of each bit position in all columns of the registers. For example, column 0 includes the bit in position 0 of each of the registers 700-703. Column 6 includes the bit in position 6 of each of the registers 700-703. The bit-wise OR function performed on the columns produces a resultant logic vector as indicated in FIG. 8A as bits 1100001 (the bottom row of bits).

After the resultant logic vector is produced, a 2M−1 by 2M−1 array of bits is generated. This is achieved by successively rotating the bits of the resultant logic vector for a predetermined number rotations. The predetermined number of rotations equals 2M−2. This produces the same result as if the actual bits in the register cells of each of the registers 700-703 were rotated, and the resultant logic vector (bit-wise OR) of each bit position in each register is calculated after each rotation.

FIG. 8B shows an array of bits that is generated based on the resultant logic vector. In the example, M=4, thus 2M−1=7. Therefore, the array of bits is a 7 by 7 array. In other words, the array includes 7 columns and seven rows of bits in which one of the rows is the resultant logic vector. Thus, to generate a 7 by 7 array of bits, the bits of resultant logic vector are successively rotated six rotations. For example, row 1 is generated by rotating the bits of row 0 (resultant logic vector) once. Row 2 is generated by rotating the bits of the row 1 once, and so on. In other words, except for row 0 (resultant logic vector), each of the rows is generated by rotating the bits of the preceding row once to the right.

After the rows of the array of bits are generated, one of rows that meets three predetermined conditions is located. The three predetermined conditions include:

1. The row that has logic 1 bit in the left-most position;

2. The row that has the minimum spacing between the left-most and right-most logic 1 bit; and

3. If more than one row has the first two properties, choose the row associated with the fewest rotations.

In the example shown in FIG. 8B, row 1 meets the three requirements. Next, having identified the row that meets these requirements, note the number of rotations that were used to create this row in the array, and then rotate the bits of the register cells in each of the registers with that same number of rotations.

FIGS. 9A-9B show the bits of registers 700-703 before and after they have been successively rotated by the same number of rotations that the resultant logic vector has been rotated to produce the selected row. FIG. 9A shows the bits of registers 700-703 before the bits are rotated. This is the same as the bits received at the register cells of registers 700-703 right after the registers are disabled. FIG. 9B shows the bits of the registers after one rotation, which is the same number of rotations that the resultant logic vector has been rotated to produce the selected row of the array shown in FIG. 8B.

After the bits of registers 700-703 are rotated as shown in FIG. 9B, the registers are set based on the contents of the register cells. Setting the registers is described in detail in the description of FIG. 10 below. After the registers are set, they correct the misalignment of the bits in terms of bit time interval during transmission on the bus lines.

In some cases, there is no misalignment among the bits, i.e., logic 1 bits of the column are aligned. In this case, all register circuits are set the same to have a minimum number of bit time intervals on the propagation path. For example, in register circuit 306 shown in FIG. 5, if there is no misalignment among the bits, the propagation path from input 302 to output 304 includes a path via line 540.

FIG. 10 shows a plurality of register circuits with B=4. In the Figure, four register circuits 1020, 1021, 1022 and 1023 include registers 1000, 1001, 1002 and 1003. The register circuits include inputs connected to four bus lines 1010, 1011, 1012 and 1013. Each of the register circuits 1020-1023 is similar to register circuit 306 shown in FIG. 5. For simplicity, some elements of register circuits 1020-1023 are not shown in FIG. 10. To illustrate how the registers 1000-1003 are set, it is assumed that the contents of the register cells of registers 1000-1003 represent the contents of registers 700-703 shown in FIG. 9B. As described in FIG. 9B, the bits in the registers at this point have been rotated based on the selected row of the array.

Based on the bits of registers 1000-1003 in the rotated position, the M:1 MUX selects the signal on an output line that connects to the output of register cell that contains the logic 1 bit. For example, at register 1000 of FIG. 10, the M:1 MUX of register 1000 selects the signal on the output line indicated by 1050, because output line 1050 connects to the register cell that contains the logic 1 bit. At register 1001, the M:1 MUX of register 1001 selects the signal on the output line indicated by 1051. In a similar manner, the 4:1 MUXs of registers 1002 and 1003 select the signals on output lines 1052 and 1053, respectively. After the M:1 MUX of each register circuit is set to select a path through the register cell that contains the logic 1 bit, the register circuits remain in this set or fixed position after the initialization process. In FIG. 10, the set position in each register circuit is indicated by paths 1060, 1061, 1062 and 1063, which are shown in dashed lines. These are the paths that the bits transmitted after the initialization process will propagate on.

Setting the paths through the register circuits as described in FIG. 10 provides two results: first, the output of the M:1 MUX of each register circuit presents a realigned bit that is passed to the next element of the IC or the system. Second, the number of bit time intervals in each register is the minimum number necessary to correct the misalignment among the bits during transmission on the bus lines.

Referring back to FIG. 7A, the training bits received at registers 700-703 at the beginning of the initialization process are not aligned. In other words, the training bits do not arrive at the registers at the same bit time interval. For instance, if the bits in register 700 are used as a reference, by looking at logic 1 bits in registers 700 and 701, logic 1 bit in register 701 arrives one bit time interval earlier than logic 1 bit in register 700. Similarly, logic 1 bit in register 702 arrives one bit time interval later than logic 1 bit in register 700. In register 703, logic 1 bit arrives at the same bit time interval as logic 1 bit of register 700. The initialization process set the registers such that bits that are output at the output of the M:1 MUXs are realigned.

After the initialization, referring to FIG. 10, the misalignments among the bits are corrected by setting registers 1000-1003 (which represents registers 700-703) accordingly to introduce the right amount of compensation, in bit time interval, to correct the misalignment. For instance, assume that the path 1060 of register circuit 1020 is used as a reference path. This is equivalent to using the bits of register 700 as a reference at the beginning of the initialization process. By looking at path 1061 of register circuit 1021, the bits on this path propagate one register cell more than the bits that propagate on path 1060. If the propagation of a bit through each register cell is equivalent to one bit time interval, propagating through one extra register cell will increase the propagation time, or slow down the bit by one time interval. Thus, the bits that propagate on path 1061 are slowed down by one bit time interval in relation to the bits that propagate on path 1060. However, this slowdown by one bit time interval is the right amount that is needed for the compensation, because at the beginning of the initialization, the bits that arrive at register 1001 (on path 1061) are one bit time interval earlier than the bits that arrive at register 1000 (on path 1060).

The bits on path 1062 propagate through one register cell fewer than the bits that propagate on path 1060. Thus, the bits that propagate on path 1061 are sped up by one bit time interval in relation to the bits that propagate on path 1060. This compensates for the late arrival by one bit time interval of the bits of the register 1002 at the beginning of the initialization process. The bits on paths 1063 and 1060 propagate through the same number of register cells. Thus, the propagation time for the bits that propagate on both paths is the same and no compensation is needed. This is also consistent with bits that are received at the same bit time interval between registers 1000 and 1001.

FIG. 11 shows a block diagram of a logic circuit 1100. Logic circuit 1100 represents one embodiment of logic circuit 308 shown in FIG. 3 in which the OR function is performed, the 2M−1 by 2M−1 array is generated, and the number of rotations is determined. Logic circuit 1100 includes a calculation unit 1110, an array of memory units 1120, a counter 1130, and a count and detect logic 1140.

Logic circuit 1100 further includes a plurality of input line groups P0-PX. Each of the input line groups P0-PX includes a plurality of input lines in which the number of input lines is indicated by B. For simplicity, each of the input line groups is represented in FIG. 11 as one line.

Logic calculation unit 1110 includes a plurality of combinational circuits OR0-ORX. Each of the combinational circuits OR0-ORX includes a plurality of inputs connected to one of the input line groups P0-PX and an output connected to one of a plurality of output lines R0-RX.

Array of memory units 1120 includes a plurality of inputs connected to output lines R0-RX, a plurality of outputs connected to lines S0-SX, and a plurality of memory units 1122. Memory units 1122 are arranged in rows and columns. The rows are indicated by Row-0 to Row-X. The rows and columns form a 2M−1 by 2M−1 array, where M is a maximum number of bit time intervals of misalignment of a parallel bus that connects to the integrated circuit such as bus 106 (FIG. 1) or 206 (FIG. 2). The memory units in the same row form a shift register, which has an output connected to one of the lines S0-SX. For example, the memory units in Row-0 form a shift register which has an output connected to line S0, the memory units in Row-1 form a shift register which has an output connected to line S1, and the memory units in Row-X for m a shift register which has an output connected to line SX.

Counter 1130 includes a plurality of counter units C0-CX. Each of the counter units C0-CX includes an input connected to one of the outputs S0-SX and an output connected to one of a plurality of output lines CO0-COX.

Count and detect logic 1140 includes a plurality of inputs connected to output lines CO0-COX of counter 1130. Count and detect logic 1140 also includes an output connected to line 1150 to provide a rotation number signal Rotate_Num.

In the embodiment represented by FIG. 11, B represents the number of bus lines, such as the number of bus lines 106-0 to 106-N shown in FIG. 1. For example, in FIG. 11, if the number of bus lines equals 4, then B=4. Therefore, each of the input line groups P0-PX includes 4 lines. In FIG. 11, each of the input line groups P0-PX includes lines that come from register cells that have the same register cell position. For example, input line group P0 includes lines from all register cells in position 0 such as register cells that are in the same position as register cell 522-0 of register 520 shown in FIG. 5; input line group P1 includes lines from all register cells in position 1 such as register cell 522-1. Further, in the embodiment represented by FIG. 11, X equals 2M−2, where M is a maximum number of bit time intervals of misalignment of a parallel bus that connects to the integrated circuit such as bus 106 or 206 shown in FIG. 1 or FIG. 2.

The operation of logic circuit 1100 is now described. In general, calculation unit 1110 performs the OR function such as the OR function described in connection with the embodiment represented by FIG. 8A. Based on the result of the OR function, array of memory units 1120 generates a 2M−1 by 2M−1 array of bits such as the array represented by FIG. 8B. Based on the content of array 1120, counter 1130 and count and detect logic 1140 determine the number of rotations to set the registers, such as register 520 shown in FIG. 5.

Referring to FIG. 11, each of the input line groups P0-PX provides B number of bits to the corresponding combinational circuits OR0-ORX. Each of the combinational circuits OR0-ORX performs a logic OR function on the received bits and provides the result on one of the lines R0-RX. For example, combinational circuit OR0 performs an OR function on the B number of bits received from input line group P0 and provides a single resultant bit on line R0. The resultant bit on line R0 is either a logic 1 bit or a logic 0 bit. Thus, after the OR function is performed by calculation unit 1110, a 2M−1 number of resultant bits are provided on lines R0-RX. The resultant bits in FIG. 11 are represented by the bits of the resultant logic vector as described previously in connection with FIG. 8A. In FIG. 11, the labels 0, 1, . . . , 2M−2 indicate bit positions of the resultant bits.

After the resultant bits are produced, a 2M−1 by 2M−1 array of bits is generated and is stored in memory units 1122. In one embodiment, the 2M−1 by 2M−1 array of bits is generated by the same method as the method that was described in connection with FIG. 8B, that is, first loading the 2M−1 number of the resultant bits into the memory units of Row-0. Then the content of Row-0 is successively rotated to produce the content of other rows (Row-1 to Row-X). In other words, after loading the resultant bits into Row-0, the content of Row-0 is rotated once to produce the content of Row-1. Next, the content of Row-1 is rotated once to produce the content of Row-2. This process repeats for Row-2 and subsequent rows until Row-X is produced.

In another method, instead of successively rotating the rows to generate the 2M−1 by 2M−1 array, the array is generated by simultaneously loading the resultant bits from lines R0-RX into memory units 1122 based on pre-assigned positions such as positions 0, 1, 2 . . . . 2M−2 shown in FIG. 11. In other words, the contents of Row-0 to Row-X are loaded in parallel to generate the entire array of bits in one step without successively rotating the rows. For example, in FIG. 11, the label in each memory unit indicates a bit position corresponding to one of the output of lines R0-RX from which the memory unit receives the bit value. When the LOAD signal is activated, the bit in position 0 (line R0) is simultaneously loaded into all memory units that have a label 0, bit in the position 1 (line R1) is simultaneously loaded into all memory units that have a label 1, and bit in the position X (line PX) is simultaneously loaded into all memory units that have a label X. Bits in positions 0 through X on lines R0-RX are loaded at the same time into corresponding memory units 1122.

After the 2M−1 by 2M−1 array of bits is generated, each of the rows is examined to select one row that meets the three predetermined conditions as described previously in connection with FIG. 8B. To examine each row, the content of each row is provided to a corresponding counter unit C0-CX of counter 1130. In the embodiment of FIG. 11, since each row operates as a shift register, the content of each row is serially shifted to the corresponding counter unit. Each counter unit counts the number of bit time intervals between logic 1 bits in a corresponding row and provides the result to count and detect logic 1140. Based on the result from the counter, count and detect logic 1140 determines from among the rows one that meet the three predetermined conditions. Based on the row position of the row that meets these three predetermined conditions, a number of rotations is determined and is provided on line 1150 as the Rotate_Num signal.

For example, if Row-2 is the row that meets the three predetermined conditions, then the number of rotations is two, because Row-2 is pre-assigned to receive the resultant bits such that the resultant bits are loaded into Row-2 as if the bits of Row-0 were successively rotated two times. As shown in FIG. 11, in Row-2, the bits in position 2M−2 are loaded into memory units of Row-2 in position 1, which is two right-rotations from position 2M−2 of Row-0.

The Rotate_Num signal, which presents the number of rotations, is provided to a controller such as controller 310 shown in FIG. 3. Based on the number of rotations, controller 310 configures the register circuit, such as register circuit 306 of FIG. 5. Referring to FIG. 5, after receiving the number of rotations, the controller activates the Mux_En signal to allow the contents of register cells 522-0 to 522-6 to be shifted and rotated to the right through MUX 506. Controller 310 also activates the Reg_En for a certain number of clock cycles that equals the number of rotation. This ensures that the contents of register cells 522-0 to 522-6 are shifted and rotated only by a number of times equaled to the number of rotations. When the Reg_En signal is disabled after the certain number of clock cycles, the content of register cells 522-0 to 522-6 are ready for select circuit 530 to set a correct path from line 510 to 304.

After the Reg_En signal is disabled, controller 310 activates the Encoder_En to activate encoder 532. Based on the signals on lines 540-543, encoder 532 determines which one of the four register cells 522-0 to 522-3 has a logic 1 bit. Based on the logic 1 bit of one of the four register cells, encoder 532 activates the SO-1 and SO-2 signals such that for each combination of the SO-1 and SO-2 signals, MUX 534 is set to allow only one of the lines 540-543 to be part of a conductive path that connects between line 510 and line 304.

In the embodiment represented by FIG. 11, the OR function is performed by combinational circuits OR0-ORX in which each of the combinational circuits includes logic gates such as OR gates to perform the OR function. However, the OR function can also be performed by other methods known to those skilled in the art. For example, the OR function can be also performed by a well-known wired-OR method. In the wired-OR method, all input lines of an input line group, e.g., all B lines of each of the input line groups P0-PX, are connected together at a node. The node is precharged to a certain voltage level that represents a logic level, e.g., HIGH. When one of the wires connected to a register cell has a different voltage level, e.g., HIGH, the node will be pulled to a different voltage level that represents a different logic level, e.g., LOW.

FIG. 12 is a state diagram for logic circuit 1100 of FIG. 11. In FIG. 12, at state 1202, logic circuit 1100 is reset. This includes, for example, resetting register circuits 306-0 to 306-N of FIG. 3, and counter 1130 of FIG. 11. At state 1204, the resultant bits on lines R0-RX are loaded into array of memory units 1120. At state 1206, the contents of Row-0 to Row-X are shifted to counter 1130, which counts the number of bit time intervals between logic 1 bits in each of the rows. At state 1208, count and detect logic 1140 evaluates the rows to determine the number of spacing between the left-most and right-most logic 1 bits. At state 1210 the number of rotations is determined. At state 1212, the contents of the register cells, such as register cells 522-0 to 522-6 of register 520 of FIG. 5, are rotated. At state 1214, after the contents of the register cells are rotated, all multiplexers such as MUX M:1 of FIG. 5 are set to correct any misalignment among the bits of the parallel bus. At state 1216, the process of setting the registers is complete.

FIG. 13 is a flow chart 1300 describing a method of configuring an integrated circuit that connects to a parallel bus. Flow chart 1300 includes the initialization process that is described in connection with FIGS. 6-12. In one embodiment, flow chart 1300 describes a method of aligning bits that are misaligned by one or more bit time intervals after the bits are transmitted on the parallel bus.

In box 1302, a pattern of training bits is repeatedly transmitted on a parallel bus that includes a plurality of bus lines. Transmitting a pattern of training bits in this step is similar to transmitting a pattern of training bits that is described in connection with FIG. 6.

In box 1304, the pattern of training bits is propagated or loaded into a plurality of latches or register cells of a register that connects to a corresponding bus line. After the training bits fill all the register cells, the registers are disabled. Propagating the bits into registers in this step is similar to propagating the pattern of training bits that is described in connection with FIG. 7A.

In box 1306, a logic function is performed on the bits in the register. The logic function in this step is similar to the logic function described in connection with FIGS. 8A. The logic function includes a bit-wise OR function, which performs an OR function on all bits of each bit position of the registers. The bit-wise OR function generates a resultant logic vector.

In box 1308, a 2M−1 by 2M−1 array of bits is generated. M is the maximum number of bit time intervals of misalignment that the IC can tolerate. The array of bits is generated by successively rotating the resultant logic vector for a number of rotations. The number of rotations is 2M−2. Generating the array of bits in box 1308 is similar to generating the array of bits that is described in connection with FIGS. 8B.

In box 1310, a selected row of the array of bits is identified. The selected row is identified based on three predetermined properties, which are similar to the properties described in connection with FIG. 8B. After the functions in boxes 1306 to 1308 are performed, the actual number of bit time intervals of misalignment among the bits is determined. In some cases, the number of bit time intervals of misalignment among the bits may be zero. The register is set such that it allows a bit to pass through the register with a minimum number of bit time intervals.

In box 1312 the bits in the registers are rotated. The number of rotations is the same number of rotations that is successively applied to the resultant logic vector to generate the selected row of the array of bits. Rotating the bits of the registers in this step is similar to rotating the bits of the registers that is described in connection with FIGS. 9A-9B.

In box 1314, each register is set based on the position of logic 1 bit in the register cells of each register. The setting of each register in this step is similar to setting of each register described in connection with FIGS. 10A-10B. After the register is set, it remains in the set position such that bits that are propagating through the register to an output associated with the register are respectively aligned with bits at outputs associated with other registers.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is intended that this invention be limited only by the claims and the equivalents thereof.

What is claimed is:

1. A circuit comprising:
a shift register connected to an input node, the shift register including a plurality of register cells;
a select circuit connected to a subset of the plurality of register cells through a number of select lines, the select circuit including an output node; and
a controller connected to the select circuit and the register cells to configure the register cells to select only one of the select lines to be a part of a conductive path connected between the input node and the output node.

2. The integrated circuit of claim 1, wherein the number of register cells equals 2M−1, where M is a maximum number of bit time intervals of misalignment of a parallel bus that connects to the integrated circuit.

3. The integrated circuit of claim 1, wherein the number of select lines equals a maximum number of bit time intervals of misalignment of a parallel bus that connects to the integrated circuit.

4. The integrated circuit of claim 1, wherein the select circuit includes:
an encoder including a plurality of inputs connected to the select lines, and a plurality of encoder outputs; and
a multiplexer including a plurality of inputs connected to the select lines, a plurality of multiplexer inputs connected to the encoder outputs, and a multiplexer output connected to the output node of the select circuit such that the multiplexer is set to pass only data bits to the multiplexer output node from a select line that is configured by the controller.

5. The integrated circuit of claim 1 further comprising a logic circuit connected to the register cells to perform a logic function on data held in the register cells.

6. The integrated circuit of claim 5, wherein the logic circuit includes:
a calculation unit to perform a logic function on a plurality of bits;
a plurality of memory units to store results from the logic function;
a counter to count values stored in the memory units; and
a detect logic responsive to the counter to generate a rotation number, the rotation number being used to rotate the data held in the register cells.

7. The integrated circuit of claim 6, wherein the logic function performs an OR function.

8. The integrated circuit of claim 7, wherein the memory units are arranged in rows and columns, wherein the memory units in the same row form a shift register.

9. The integrated circuit of claim 8, wherein the counter includes a plurality of counter memory units, each of the counter memory units being connected to one shift register.

10. An integrated circuit comprising:
a plurality of input nodes to receive a plurality of input bits;
a plurality of output nodes to provide a plurality of output bits;
a plurality of register circuits, each of the register circuits being connected between one of the input nodes and one of the output nodes;
a logic circuit connected to the register circuits to perform a logic function on a plurality of bits held by the register circuits; and
a controller to configure the register circuits based on a result from the logic circuit to align the plurality of output bits provided by one output node with a plurality of output bits provided by other output nodes when the plurality of input bits received at the input nodes are misaligned by one or more bit time intervals.

11. The integrated circuit of claim 10, wherein each of the register circuits includes a number of register cells, wherein the number of register cells equals 2M−1, where M is a maximum number of bit time intervals of misalignment of a parallel bus that connects to the integrated circuit.

12. The integrated circuit of claim 11, wherein each of the register circuits further includes a select circuit connected to a subset of the number of register cells through a number of select lines.

13. The integrated circuit of claim 12, wherein the number of select lines equals a maximum number of bit time intervals of misalignment of a parallel bus that connects to the integrated circuit.

14. The integrated circuit of claim 13, wherein the logic circuit includes:
a calculation unit to perform a logic function on a plurality of bits;
a plurality of memory units to store results from the logic function;
a counter to count values stored in the memory units; and
a detect logic to determine results from the counter and to generate a rotation number, the rotation number being used to rotate data held in the number of register cells.

15. The integrated circuit of claim 10, wherein the logic function performs an OR function.

16. The integrated circuit of claim 14, wherein the memory units are arranged in rows and columns, wherein the memory units in the same row form a shift register.

17. The integrated circuit of claim 14, wherein the counter includes a plurality of counter memory units, each of the counter memory units being connected to one shift register.

18. A system comprising:
a parallel bus including a plurality of bus lines to carry a plurality of bits on each of the bus lines; and
a first integrated circuit including a plurality of register circuits, each of the register circuits being connected to one of the bus lines, and each of the register circuits including,
a shift register connected to an input node, the shift register including a plurality of register cells,
a select circuit connected to a subset of the number of register cells through a number of select lines, the select circuit including an output node, and
a controller connected to the select circuit and the register cells to configure the register cells to select only one of the select lines to be a part of a conductive path connected between the input node and the select circuit output node.

19. The system of claim 18 further comprising a second integrated circuit connected to the parallel bus.

20. The system of claim 19, wherein the parallel bus is formed on a circuit board, and the first and second integrated circuits are located in the circuit board.

21. The system of claim 19 further comprising:
a first circuit board, wherein the parallel bus is formed on the first circuit board and the first integrated circuit is located on the first circuit board; and
a second circuit board, wherein the second integrated circuit is located on the second circuit board, the second circuit board being inserted into a bus slot that connects to the parallel bus.

22. The system of claim 19, wherein the first and second integrated circuits are located on separate circuit boards, and the parallel bus is not formed on the first or second circuit boards.

23. A method of aligning bits on a parallel bus, the method comprising:
receiving at each of a plurality of registers a plurality of training bits transmitted on each of a plurality of bus lines of a parallel bus during an initialization process;
determining an actual number of bit time intervals of misalignment among the plurality of training bits during transmission on the parallel bus lines based on the plurality of training bits; and
configuring the registers based on the actual number of bit time intervals of misalignment to align subsequent functional bits transmitted on each of the bus lines of the parallel bus after the initialization process, in which the subsequent functional bits are misaligned by at least one bit time interval during transmission on the parallel bus.

24. The method of claim 23, wherein receiving a plurality of training bits includes receiving a pattern of bits, the pattern of bits including a bit that represents a first logic value and a plurality of bits that represents a second logic value.

25. The method of claim 23, wherein receiving a plurality of training bits includes receiving a pattern of bits, the pattern of bits including a bit that represents a first logic value and 2M−2 number of bits that represents a second logic value, wherein M is the maximum number of bit time intervals of misalignment that the integrated circuit can tolerate.

26. The method of claim 23, wherein determining an actual number of bit time intervals of misalignment includes:
performing a logic function on each bit position of each of the registers to produce a plurality of resultant bits;
generating an array of bits based on the resultant bits; and
selecting a row of bits from the array of bits.

27. A method of aligning bits on a parallel bus, the method comprising:
loading a plurality of training bits transmitted on each of a plurality of bus lines into each of a plurality of registers;
performing a logic function on the training bits loaded in the registers to produce a plurality of resultant bits;
generating an array of bits based on the resultant bits;
determining a number of rotations based on the array of bits;
rotating the training bits in the plurality of registers based on the number of rotations; and
configuring transmission paths between the plurality of bus lines and a plurality of outputs based on logic values of bits in the registers.

28. The method of claim 27, wherein transmitting a plurality of training bits includes transmitting a pattern of bits, the pattern of bits including a bit that represents a first logic value and a plurality of bits that represents a second logic value.

29. The method of claim 27, wherein transmitting a plurality of training bits includes transmitting a pattern of bits, the pattern of bits including one bit that represents a first logic value and 2M−2 number of bits that represents a second logic value, wherein M is a maximum number of bit time intervals of misalignment that the integrated circuit can tolerate.

30. The method of claim 27, wherein generating an array of bits includes generating a 2M−1 by 2M−1 array of bits, wherein M is a maximum number of bit time intervals of misalignment of the parallel bus.
